(19) United States
(12) Patent Application Publication
(10) Pub. No.: US 2006/0099950 A1
(43) Pub. Date: May 11, 2006

(54) Method and apparatus for activating an inactive mobile unit in a distributed network

(76) Inventors: Thierry E. Klein, Fanwood, NJ (US); Sureshbabu P. Nair, Whippany, NJ (US); Ajay Rajkumar, Morristown, NJ (US); Michael D. Turner, Madison, NJ (US)

Correspondence Address: WILLIAMS, MORGAN & AMERSON, 10333 RICHMOND, SUITE 1100, HOUSTON, TX, 77042, US

(21) Appl. No.: 11/209,533

(22) Filed: Aug. 23, 2005

Related U.S. Application Data
(63) Continuation-in-part of application No. 10/984,020, filed on Nov. 8, 2004.

(51) Int. Cl. H04Q 7/20

(52) U.S. Cl. 455/439

(57) ABSTRACT

The present invention provides a method of wireless communication in a distributed network comprised of a mobile unit, a plurality of gateways, and a plurality of base stations associated with the gateways. The method includes receiving information indicative of a first base station from a first gateway associated with the first base station in response to the mobile unit handing off from a second base station to the first base station. The mobile unit may be inactive.

### CROSS REFERENCE TO RELATED APPLICATIONS

This application is a continuation-in-part of U.S. patent application Ser. No. 10/984,020, filed on Nov. 8, 2004 and entitled, “Method and Apparatus for Activating a Dormant Mobile Unit in a Distributed Network.”

### BACKGROUND OF THE INVENTION

1. Field of the Invention

This invention relates generally to a communication system, and, more particularly, to a wireless communication system.

2. Description of the Related Art

In conventional wireless communications, one or more mobile units may establish a wireless link to a Radio Access Network (RAN). The RAN architecture is typically hierarchical and call state information associated with each mobile unit call session is stored in a central repository, such as a Radio Network Controller (RNC), a Packet Data Serving Node (PDSN), and the like. If the user of the mobile unit changes geographical location while the mobile unit is dormant, a paging process may be used to locate the mobile unit. For example, the paging process may be initiated when data intended for the mobile unit arrives at a radio network controller. Upon receiving the page, the mobile unit may transmit an identifier, such as a Unicast Access Terminal Identifier (UATI), which may be used to locate the appropriate call state information in the central repository. The mobile unit may also re-activate the dormant session, in which case the UATI is transmitted and used to locate the appropriate call state information in the central repository.

A first alternative to the conventional hierarchical network architecture is a distributed architecture including a network of base station routers. For example, each base station router may combine RNC and/or PDSN functions in a single entity that manages radio links between one or more mobile units and an outside network, such as the Internet. Compared to hierarchical networks, distributed architectures have the potential to reduce the cost and/or complexity of deploying the network, as well as the cost and/or complexity of adding additional wireless access points, e.g. base station routers, to expand the coverage of an existing network. Distributed networks may also reduce (relative to hierarchical networks) the delays experienced by users because packet queuing delays at the RNC and PDSN of hierarchical networks may be reduced or removed.

In a distributed network of base station routers, one or more mobile units may establish a call session with any one of the plurality of base station routers. Accordingly, each base station router should be capable of assigning an identifier, such as a UATI, to the mobile unit. For example, a proposed Code Division Multiple Access (CDMA) protocol standard, sometimes referred to as the EVolution-Data Optimized (EVDO) standard, specifies a unique 128-bit UATI that is assigned to a mobile unit when a call session is initiated by the mobile unit. The mobile unit maintains the UATI for the duration of the call session. In the current implementation, the EVDO call session UATI is divided into two parts: a 104-bit UATI104 and a 24-bit UATI024. The UATI024 portion is unique to the mobile unit for the duration of the call session and the UATI104 is common to all mobile units within a predetermined subnet of base station routers in the distributed network.

In operation, base station routers in a conventional distributed network broadcast, or advertise, their subnet address, e.g. the address indicated by the UATI104 portion of the UATI. However, the address is generally too long to advertise on a control channel, so the base station routers advertise an 8-bit alias to the subnet address called a color code. Mobile units may then determine whether or not the subnet including the base station router providing service to the mobile unit has changed by monitoring the advertised color code on the control channel. If the mobile unit detects a change in the color code, the mobile unit is typically required to request a new UATI. For example, a mobile unit may initiate a call session with a first base station router belonging to a first subnet having a first color code. The first base station router assigns a UATI to the mobile unit. If the mobile unit becomes dormant and later re-activates by sending a message to a second base station router belonging to a second subnet having a second color code, the mobile unit should request a new UATI from the second base station router.

However, the base station routers may have difficulty locating call session information associated with the dormant call session when the dormant mobile unit is re-activated. For example, after a mobile unit may initiate a call session with a first base station router, the mobile unit may be handed off to a second base station router, which may also receive and store the associated call state information. If the mobile unit then becomes dormant and later re-activates by sending a message to a third base station router, the third base station router may not be able to locate the call session information stored on the second base station router.

A second alternative to the conventional hierarchical network architecture is a distributed architecture including a network of routers that operate according to the IEEE 802.16 standard. For example, the network may include a plurality of WiMAX routers (WMRs) that provide wireless connectivity to mobile units (which may also be referred to as mobile subscriber stations) according to the IEEE 802.16 standard. WiMAX is a standards-based technology enabling the delivery of last mile wireless broadband access as an alternative to a cable and/or a digital subscriber line (DSL). Conventional WiMAX routers may provide fixed, nomadic, portable, and/or mobile wireless broadband connectivity without the need for a direct line-of-sight to a base station. Each WMR may implement the functionality of the hierarchical RAN elements, such as described above. At least in part to conserve power, mobile units may enter an inactive mode when the mobile unit is not actively transmitting or receiving data. An inactive mobile unit typically exchanges information with a single base station, which is the anchor base station in the active set of base stations and may be referred to as the preferred base station.

The IEEE 802.16 standard defines two inactive modes: the sleep mode and the idle mode. The sleep mode is a pre-negotiated period of absence from the air interface associated with a serving base station. Mobile units that are in sleep mode are unavailable for forward and/or reverse link traffic. During the unavailability interval, the serving base station may not transmit any data to the mobile unit and the mobile unit may power down and/or perform other activities that do not require any communication with the base station. Sleep mode activities may include scanning different frequencies, ranging of neighboring base stations, and the like. The idle mode begins when a mobile unit transmits a de-registration message to the serving base station. The serving base station may then tear down the traffic channel associated with the idle mobile unit and release all information pertaining to the idle mobile unit's network connections. The mobile unit may only listen while in the idle mode and can only receive messages from its preferred base station. A sleeping mobile unit is typically unavailable to the network for relatively shorter time intervals and an idle mobile unit is typically unavailable to the network for relatively longer time intervals. Furthermore, the media access control (MAC) state information for the session is not torn down when the mobile unit enters the sleep mode, whereas the mobile unit explicitly de-registers its MAC state for the duration of the idle state.

A mobile unit may move while it is inactive. In sleep mode, the mobile unit may detect a new preferred base station as it moves, e.g., by monitoring a pilot signal strength. If the mobile unit selects a different preferred base station, normal handoff procedures may be used to transfer information associated with the mobile unit, such as the MAC state information, to the new preferred base station as if the mobile unit were in the active state. In the idle mode, a moving mobile unit may periodically reselect a preferred base station and synchronize to the corresponding broadcast paging interval. However, in contrast to sleep mode, the mobile unit need not inform the new base station that it has been selected as the preferred base station. Thus, states associated with the mobile unit may not be moved until the mobile unit leaves the idle mode when forward link and/or reverse link traffic resumes.

Information associated with a larger public network attachment is not typically migrated when an inactive mobile unit moves. For example, if the mobile unit moves from a base station served by a first WMR to a base station served by a second WMR, the system does not move the call-session state information that is unrelated to the MAC state information from the first WMR to the second WMR. In the sleep mode, the mobile unit does not even retain knowledge of the location of the first WMR that contains the call-session state information unrelated to the MAC state information, which may include information required to establish and/or maintain the connection to the larger network. In the idle mode, the mobile unit may not perform handover procedures as it moves from one serving base station to another, as discussed above, and the system may not migrate call-session state information from the first WMR to the second WMR. However, an idle mobile unit may retain knowledge of the WMR that includes call-session state information.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the instant invention, a method is provided for wireless communication in a distributed network comprised of a mobile unit, a plurality of gateways, and a plurality of base stations associated with the gateways. The method includes receiving information indicative of a first base station from a first gateway associated with the first base station in response to the mobile unit handing off from a second base station to the first base station. The mobile unit may be inactive.

In another embodiment of the present invention, a method is provided for wireless communication in a distributed network comprised of a mobile unit, a plurality of gateways, and a plurality of base stations associated with the gateways. The method includes receiving information indicative of a location of call-session state information associated with the mobile unit in response to the mobile unit handing off from a first base station to a second base station. The mobile unit may be inactive.

In yet another embodiment of the present invention, a method is provided for wireless communication in a distributed network comprised of a mobile unit, a plurality of gateways, and a plurality of base stations associated with the gateways. The method includes providing information indicative of a location of call-session state information associated with the mobile unit in response to the mobile unit handing off from a first base station to a second base station. The mobile unit may be inactive.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a first exemplary embodiment of a distributed wireless communication system, in accordance with the present invention;

FIG. 2 conceptually illustrates a call session identifier that may be used in the distributed wireless communication system shown in FIG. 1, in accordance with the present invention;

FIG. 3 conceptually illustrates one embodiment of a method of migrating information prior to dormancy of a call session, in accordance with the present invention;

FIG. 4 conceptually illustrates a first embodiment of a method of re-activating a dormant call session, in accordance with the present invention;

FIG. 5 conceptually illustrates a second embodiment of a method of re-activating a dormant call session, in accordance with the present invention;

FIG. 6 conceptually illustrates a second exemplary embodiment of a distributed wireless communication system, in accordance with the present invention;

FIG. 7 conceptually illustrates one embodiment of a method of entering a sleep mode and performing a handoff while in the sleep mode, in accordance with the present invention;

FIG. 8 conceptually illustrates a first exemplary embodiment of a method of re-entry from sleep mode, in accordance with the present invention; and

FIG. 9 conceptually illustrates a second exemplary embodiment of a method of re-entry from sleep mode, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, an air interface, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

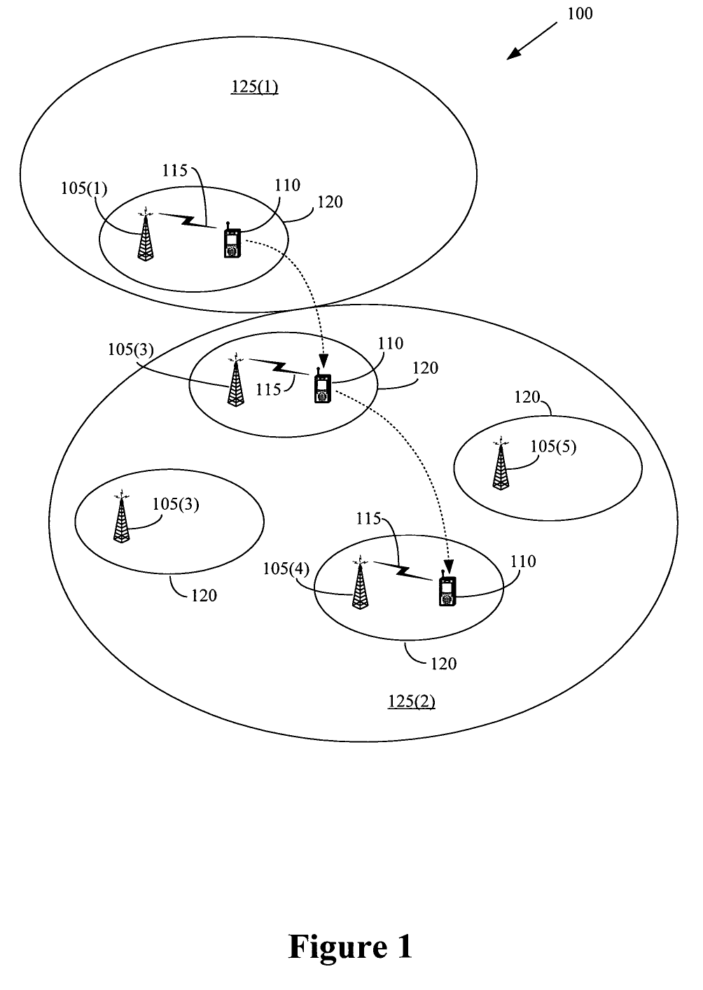

FIG. 1 conceptually illustrates a first exemplary embodiment of a distributed wireless communication system 100. In the illustrated embodiment, access points for the distributed wireless communication system 100 include a distributed network of base station routers 105(1-5). Hereinafter, in the interest of clarity, the base station routers 105(1-5) will be referred to collectively by the index 105 unless the description is referring to a specific base station router 105, such as the base station router 105(1). Although the present invention will be described in the context of the distributed wireless communication system 100 comprising a plurality of base station routers 105, persons of ordinary skill in the art should appreciate that the present invention is not limited to distributed wireless communication systems 100 in which the access points are base station routers 105. In alternative embodiments, the distributed wireless communication system 100 may include any desirable number and/or type of access point.

Each of the base station routers 105 may be capable of initiating, establishing, maintaining, transmitting, receiving, terminating, or performing any other desired action related to a call session with one or more mobile units, such as the mobile unit 110 shown in FIG. 1. For example, each base station router 105 may combine Radio Network Controller (RNC) and Packet Data Serving Node (PDSN) functions in a single entity. The base station routers 105 may also be configured to communicate with other base station routers 105, other devices, other networks, and the like in a manner known to persons of ordinary skill in the art.

The base station routers 105 provide wireless communication links 115 to mobile units 110 within an associated geographic region, referred to hereinafter as a cell 120. Subsets of the base station routers 105 in the distributed wireless communication system 100 may also be grouped into subnets 125(1-2). Each subnet 125(1-2) includes a subset of the base station routers 105, which provide wireless communication links 115 to a subset of the cells 120. The subnets 125(1-2) have a subnet address, such as a 104-bit UATI address, and may also have an 8-bit alias to the subnet address called a color code. In the interest of clarity, only two subnets 125(1-2) having one and four base station routers 105, respectively, have been depicted in FIG. 1. However, persons of ordinary skill in the art should appreciate that the present invention is not limited to this illustrative exemplary embodiment. In alternative embodiments, any desirable number of subnets 125 including any desirable number of base station routers 105 may be used.

Each base station router 105 can create, assign, transmit, receive, and/or store information related to the call sessions established between the base station routers 105 and the one or more mobile units 110. This information will be collectively referred to hereinafter as call-session state information, in accordance with common usage in the art. For example, the call-session state information may include information related to an air interface protocol, one or more sequence numbers, a re-sequencing buffer, and the like. The call-session state information may also include information related to a Point-to-Point Protocol (PPP), such as header compression information, payload compression information, and related parameters. Call-session state information related to other protocol layers may also be created, transmitted, received, and/or stored by the base station routers 105. In one embodiment, the call-session state information includes a call session identifier, such as a Unicast Access Terminal Identifier (UATI).

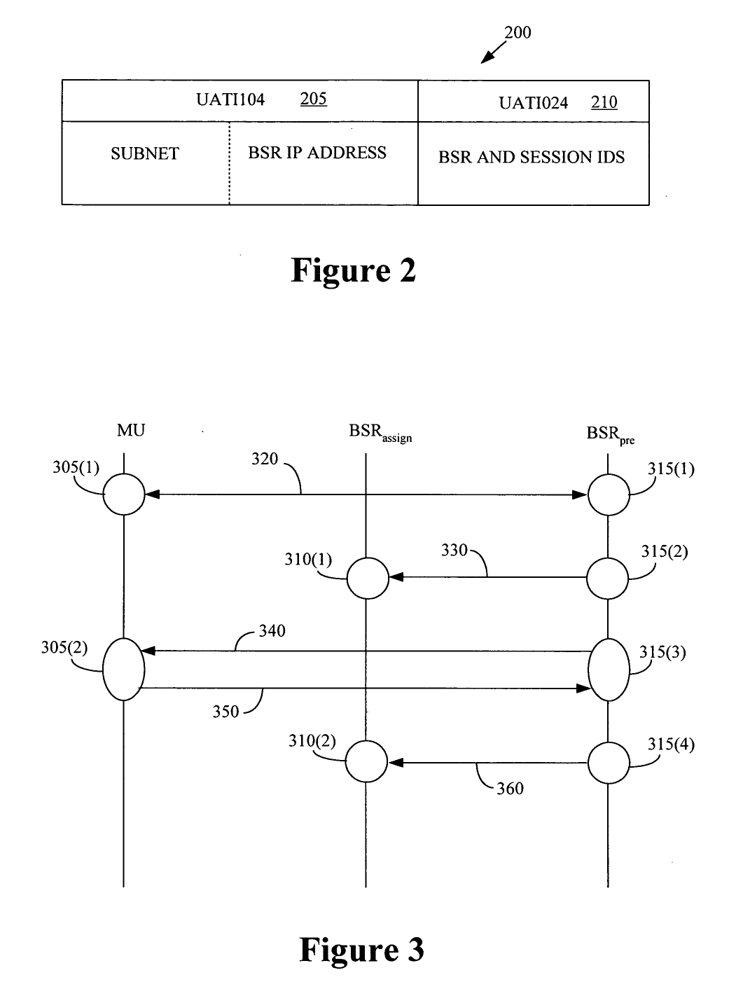

FIG. 2 conceptually illustrates a call session identifier 200 that may be used in the wireless communication system 100 shown in FIG. 1. In the illustrate embodiment, the call session identifier 200 is a UATI that includes a UATI104 portion 205 having 104 bits and a UATI024 portion 210 having 24 bits. The illustrated UATI104 portion 205 includes a 72-bit subnet identifier 215 and a 32-bit base station router IP address. The illustrated UATI024 portion 210 includes a 12-bit base station router identifier that is unique within a subnet or color code and a 12-bit call session identifier. In one embodiment, the UATI024 portion 210 and a color code uniquely identifies a call session within the distributed wireless communication system 100. Persons of ordinary skill in the art should appreciate that the present invention is not limited to this specific embodiment of a UATI call session identifier 200. In alternative embodiments, any desirable call session identifier 200 having any desirable structure and/or number of bits may be used.

In the illustrated embodiment, the 12 call session bits in the UATI024 may represent up to 4096 call sessions, which may include active and/or dormant call sessions. The 12 base station router identifier bits may represent up to 4096 base station routers within a subnet or color code. Accordingly, as will be discussed in detail below, when a mobile unit moves from a first (serving) base station to a second (target) base station within the same subnet or color code, the target base station router may identify the serving base station router using the UATI024 portion 210. The target base station router may then retrieve call session information from the serving base station router.

In one embodiment, the 8-bit color code and the 24-bit IP address in the UATI104 portion 205 may be transmitted to one or more mobile units in a sector parameter message. The mobile units may reject these messages if the relevant portions of the UATI and the sector parameter message do not match. Thus, logical IP addresses and color codes may be used in the UATI104 portion 205. The logical IP addresses may be different than the actual IP address of the base station router, so a translation table may be used to arrive at the actual IP address of a base station router. In one alternative embodiment, a range of numerical values may be used in place of the bit-based base station router identifier. This approach may allow for a more flexible range and more efficient use of the available bits.

Referring back to FIG. 1, operation of one exemplary embodiment of the distributed wireless communication system 100 will now be described. A call session is established between the mobile unit 110 and the base station router 105(1). As part of the establishment procedure, the base station router 105(1) assigns a call session identifier to the call session. As discussed above, the call session identifier may be a UATI. For example, the call session identifier may be a UATI that includes a 104-bit UATI104 having a 72-bit subnet identifier that identifies the subnet 125(1) and a 32-bit IP address for the base station router 105(1). The UATI024 may include a 12-bit identifier indicative of the base station router 105(1). The 12-bit identifier indicative of the base station router 105(1) is unique within the subnet 125(1) and/or an 8-bit color code associated with the subnet 125(1). The UATI024 also includes a 12-bit call session identifier that uniquely identifies the call session among other call sessions that may be concurrently established with the base station router 105(1).

After the call session has been established, the mobile unit 110 moves from the cell 120 served by the base station router 105(1) to the cell 120 served by the base station router 105(2). In one embodiment, the base station router 105(2) may re-assign a new UATI to the mobile unit 110, since the base station router 105(2) is in the subnet 125(2), which has a different 8-bit color code than the subnet 125(1). However, re-assignment of the UATI is not always necessary. For example, the mobile unit 110 may move to a base station router (not shown) in the same color code, in which case it may not be necessary to re-assign the UATI. Moreover, in some alternative embodiments, the mobile unit 110 may be in communication with a plurality of base station routers 105, which are usually referred to as an active set. As long as one of the base station routers 105 in the active set has the same color code as the UATI-assigning base station router 105, it may not be necessary to re-assign the UATI. In one embodiment, the call-session state information stored on the base station router 105(1) may be migrated to the base station router 105(2).

The call session associated with the mobile unit 110 then becomes dormant. Dormancy refers to the state of the mobile unit 110 after an existing traffic channel between the mobile unit 110 and the base station router 105(2) has been torn down. In various alternative embodiments, dormancy may be triggered by a user powering down the mobile unit 110, silence in a voice communication, the absence of data requiring transmission, and the like. For example, the mobile unit 110 may include a timer that starts when no voice or data is being transmitted or received. If the timer expires, the mobile unit 110 becomes dormant and the traffic channel may be torn down. Prior to becoming dormant, the mobile unit 110 may carry out one or more pre-dormancy activities, which may include migrating information between various base station routers 105.

FIG. 3 conceptually illustrates one embodiment of a method 300 of migrating information prior to dormancy of a call session. In the embodiment shown in FIG. 3, actions associated with a mobile unit (MU) are indicated by the indices 305(1-2), actions associated with an assigning base station router (BSR_{assign}) are indicated by the indices 310(1-2), and actions associated with a pre-dormancy serving base station router (BSRₚᵣₑ) are indicated by the indices 315(1-4). Arrows 320, 330, 340, 350, 360 are indicative of data transmission and/or reception during one or more of the actions 305(1-2), 310(1-2), 315(1-4). Persons of ordinary skill in the art should appreciate that the present invention is not limited to the actions 305(1-2), 310(1-2), 315(1-4). In alternative embodiments, more or fewer actions may take place during pre-dormancy migration.

At actions 305(1) and 315(1), the mobile unit (MU) and the pre-dormant (or primary) base station router (BSRₚᵣₑ) are communicating, as indicated by the arrow 320. Since it is the natural condition for all protocols to attempt to migrate to the serving base station router, i.e. the pre-dormant base station router (BSRₚᵣₑ), information may be migrated to the pre-dormant base station router (BSRₚᵣₑ) prior to going into dormancy so that the pre-dormant base station router (BSRₚᵣₑ) may contain all of the protocols for the call session. However, the call session identifier, such as a UATI, is not typically migrated from the assigning base station router (BSR_{assign}) to the pre-dormant base station router (BSRₚᵣₑ) in conventional migration schemes. Thus, in one embodiment of the present invention, the UATI is migrated from the assigning base station router (BSR_{assign}) to the pre-dormant base station router (BSRₚᵣₑ) prior to dormancy, as described in detail below. Migrating the UATI prior to dormancy may simplify the process of re-activating the dormant call.

At action 315(2), the pre-dormant base station router (BSRₚᵣₑ) provides a signal indicated by the arrow 330. The signal 330 includes a call session identifier, such as a UATI, which may be provided when data-flow has stopped after a dormancy timer has reached a predetermined time-out period. At action 310(1), the assigning base station router (BSR_{assign}), which originally assigned the UATI to the mobile unit MU, receives the signal 330 and logs the identity of the last serving primary BSR, i.e. the pre-dormant base station router (BSRₚᵣₑ).

At action 315(3), the pre-dormant base station router (BSRₚᵣₑ) sends a UATI Assignment message, indicated by arrow 340, to the mobile unit (MU) prior to traffic channel de-allocation. At action 305(2), the mobile unit (MU) receives the UATI Assignment message 340, updates its UATI for the call session, and acknowledges by sending a UATIComplete message back to the pre-dormant base station router (BSRₚᵣₑ), as indicated by the arrow 350. If this sequence completes successfully, the pre-dormant base station router (BSRₚᵣₑ) becomes the assigning base station router (BSR_{assign}).

At action 315(4), one or more messages, indicated by arrow 360, may be sent to the old assigning base station router (BSR_{assign}) telling it that a new UATI has been assigned for this call session. At action 310(2), the old assigning base station router (BSR_{assign}) receives the message 360 and frees the previously assigned UATI. The old assigning base station router (BSR_{assign}) may now allocate the previously assigned UATI to another call session.

Once the pre-dormancy migration 300 is complete, the mobile unit (MU) may become dormant. However, persons of ordinary skill in the art should appreciate that pre-dormancy migration is an optional operation and, in some embodiments, no pre-dormancy migration may occur. For example, the mobile unit (MU) may unexpectedly become dormant due to some unexpected event. Alternatively, some embodiments of the mobile unit (MU) may not be configured to execute a pre-dormancy routine such as described above.

Referring back to FIG. 1, the dormant mobile unit 110 becomes associated with the base station router 105(4). For example, the user may carry the mobile unit 110 into a region serviced by the base station router 105(4). For another example, changing environmental conditions may result in the base station router 105(4) providing superior quality of service to the mobile unit 110. However, since the mobile unit 110 is dormant, the base station router 105(4) may not be aware of the presence of the mobile unit 110. Thus, when the mobile unit 110 is re-activated, the mobile unit 110 provides an identifier indicative of the dormant call session to the base station router 105(4). The base station router 105(4) then uses the call session identifier to identify the base station router 105 that assigned the identifier indicative of the dormant call session. If the call-session state information associated with the dormant call has migrated to the base station router 105(2), then the base station router 105(4) may use the identifier to identify the base station router 105(2) directly and may access the call state information on the base station router 105(2). Alternatively, if the call-session state information associated with the dormant call has not been migrated to the base station router 105(2), then the base station router 105(4) may identify the base station router 105(1) based on the call session identifier. The base station router 105(1) may then identify the base station router 105(2) that previously provided service to the mobile unit 110 and the base station router 105(4) may access the call-session state information on the base station router 105(2). The dormant call session may then be re-activated using the accessed call-session state information.

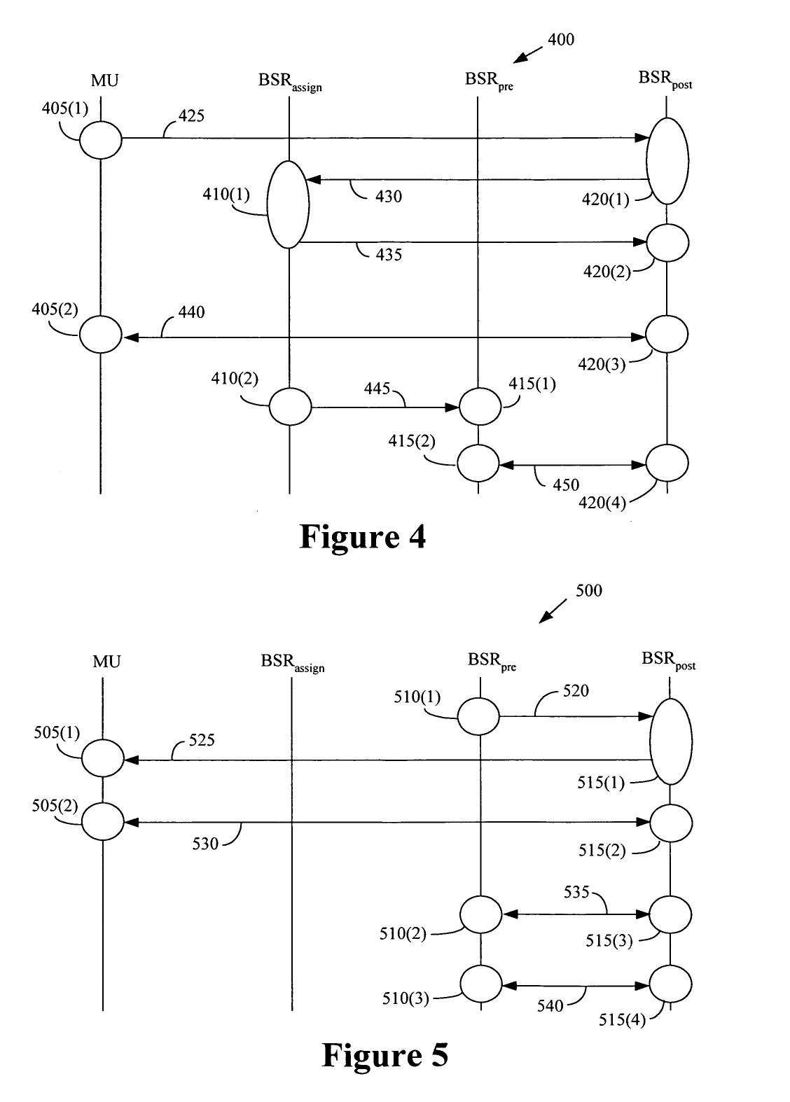

FIG. 4 conceptually illustrates a first embodiment of a method 400 of re-activating a dormant call session. In the embodiment shown in FIG. 4, actions associated with a mobile unit (MU) are indicated by the indices 405(1-2), actions associated with an assigning base station router (BSR_{assign}) are indicated by the indices 410(1-2), actions associated with a pre-dormancy base station router (BSRₚᵣₑ) are indicated by the indices 415(1-2), and actions associated with a post-dormancy base station router (BSRₚₒₛₜ) are indicated by the indices 420(1-4). Arrows 425, 430, 435, 440, 445, 450 are indicative of data transmission and/or reception during one or more of the actions 405(1-2), 410(1-2), 415(1-2), 420(1-4). Persons of ordinary skill in the art should appreciate that the present invention is not limited to the actions 405(1-2), 410(1-2), 415(1-2), 420(1-4). In alternative embodiments, more or fewer actions may take place during re-activation of a dormant call session.

In the first embodiment of the method 400, the mobile unit (MU) initiates re-activation. For example, the mobile unit (MU) may initiate re-activation based upon user input, such as a voice signal, input to a keypad, a power-up sequence, and the like. When the mobile unit (MU) wakes up from dormancy, a call session identifier may be used to find the location of the assigning base station router (BSR_{assign}), which may have call-session state information stored thereon. In the illustrated embodiment, the call session identifier is a UATI. However, persons of ordinary skill in the art should appreciate that any desirable call session identifier may be used. Alternatively, some or all of the call-session state information may be stored on the pre-dormancy base station router (BSRₚᵣₑ), and the assigning base station router (BSR_{assign}) may have information indicative of the location of the pre-dormancy base station router (BSRₚᵣₑ).

At action 405(1), the mobile unit (MU) initiates traffic channel setup procedure by sending a Connection Request Message, indicated by the arrow 425, to the post-dormancy base station router (BSRₚₒₛₜ). The Connection Request Message includes the UATI associated with the mobile unit (MU). At action 420(1), the post-dormancy base station router (BSRₚₒₛₜ) receives the Connection Request Message 425 including the UATI. Using the UATI, the post-dormancy base station router (BSRₚₒₛₜ) contacts the assigning base station router (BSR_{assign}) to verify the state of the UATI. In one embodiment, the post-dormancy base station router (BSRₚₒₛₜ) contacts the assigning base station router (BSR_{assign}) by sending a message, as indicated by the arrow 430.

At action 410(1), the assigning base station router (BSR_{assign}) determines whether or not the transmitted state of the UATI is valid. If valid, the assigning base station router (BSR_{assign}) sends the address of the pre-dormancy base station router (BSRₚᵣₑ) that served the UATI, as indicated by the arrow 435. At action 420(2), the post-dormancy base station router (BSRₚₒₛₜ) receives the message 435 including the address and prepares to instantiate forward and reverse-link Resource Layer Protocols (RLP). In one embodiment, the post-dormancy base station router (BSRₚₒₛₜ) knows to forward any reverse-link packets to PPP at the pre-dormancy base station router (BSRₚᵣₑ).

At actions 405(2) and 420(3), the post-dormancy base station router (BSRₚₒₛₜ) and the mobile unit (MU) complete the traffic channel setup procedure. In the illustrated embodiment, the traffic channel, as well as the signaling used to establish the traffic channel, is indicated by the arrow 440. Where possible, traffic channel setup can occur simultaneously with other signaling. At actions 410(2) and 415(1), the assigning base station router (BSR_{assign}) communicates with the pre-dormancy base station router (BSRₚᵣₑ), as indicated by the arrow 445. In one embodiment, the assigning base station router (BSR_{assign}) tells the pre-dormancy base station router (BSRₚᵣₑ) that the post-dormancy base station router (BSRₚₒₛₜ) is re-activating communication to the mobile unit (MU). The pre-dormancy base station router (BSRₚᵣₑ) receives the message 445 and may then reactivate its protocol stack with the exception that forward and reverse-link RLP may be done at the post-dormancy base station router (BSRₚₒₛₜ). This means that on startup, forward-link user data from PPP may be tunneled directly to the post-dormancy base station router (BSRₚₒₛₜ).

At actions 415(2) and 420(4), forward and reverse-link traffic may be tunneled between the pre-dormancy base station router (BSRₚᵣₑ) and the post-dormancy base station router (BSRₚₒₛₜ), as indicated by arrow 450. The post-dormancy base station router (BSRₚₒₛₜ) may receive the address 450 and prepare to instantiate forward and reverse-link RLP. In one embodiment, the post-dormancy base station router (BSRₚₒₛₜ) knows to forward any reverse-link packets to PPP at the pre-dormancy base station router (BSRₚᵣₑ). At this point, active migration of all BSR protocol states to the post-dormancy base station router (BSRₚₒₛₜ) may begin, as will be described in detail below.

Re-activation of the mobile unit (MU) from dormancy in the above described manner may reduce the time that may elapse before the mobile unit (MU) is able to receive traffic. In the above described embodiment, the protocol states are reactivated with RLP being done at the post-dormancy base station router (BSRₚₒₛₜ) while all of the other states are done at the pre-dormancy base station router (BSRₚᵣₑ), which last served the call session. Migration of all of the protocol states to the post-dormancy base station router (BSRₚₒₛₜ) may then proceed during the active call session.

FIG. 5 conceptually illustrates a second embodiment of a method 500 of re-activating a dormant call session, in accordance with the present invention. In the second embodiment shown in FIG. 5, actions associated with a mobile unit (MU) are indicated by the indices 505(1-2), actions associated with a pre-dormancy base station router (BSRₚᵣₑ) are indicated by the indices 510(1-3), and actions associated with a post-dormancy base station router (BSRₚₒₛₜ) are indicated by the indices 515(1-4). Arrows 520, 525, 530, 540, 545 are indicative of data transmission and/or reception during one or more of the actions 505(1-2), 510(1-3), 515(1-4). Persons of ordinary skill in the art should appreciate that the present invention is not limited to the actions 505(1-2), 510(1-3), 515(1-4). In alternative embodiments, more or fewer actions may take place during re-activation of a dormant call session.

In the second embodiment of the method 500, the distributed network initiates re-activation. In one embodiment, re-activation is initiated when data intended for the mobile unit (MU) is received by the distributed network. For example, forward-link data arriving from the network may be forwarded to the pre-dormancy base station router (BSRₚᵣₑ), which may initiate a paging process to locate the mobile unit (MU) in response to receiving the forward link data. The paging process will be discussed in greater detail below.

At action 510(1), forward-link data arriving at the pre-dormancy base station router (BSRₚᵣₑ) forces it to initiate the paging process to locate the dormant mobile unit (MU). In one embodiment, the pre-dormancy base station router (BSRₚᵣₑ) sends paging requests, as indicated by arrow 520, to neighboring BSRs according to a paging strategy. Along with the paging request 520, the IP address of the pre-dormancy base station router (BSRₚᵣₑ) is sent along with the associated UATI. In one embodiment, the paging strategy is implemented in a distributed manner in which a paging area consists of a group of neighboring base station routers. When forward link data arrives at the PPP layer on the pre-dormancy base station router (BSRₚᵣₑ), the pre-dormancy base station router (BSRₚᵣₑ) may determine the UATI associated with the mobile unit based upon the forward link data. The pre-dormancy base station router (BSRₚᵣₑ) may then translate the UATI to determine the base station router's IP address and use this address to send page messages to other base station routers in a subnet indicated by a color code in the UATI. In one embodiment, the paging strategy may also include defining one or more subgroups so that paging may be done in an optimal manner without utilizing all of the resources of the pre-dormancy base station router (BSRₚᵣₑ). If the pre-dormancy base station router (BSRₚᵣₑ) is at or near a color code boundary, the paging subgroups could exist in multiple color codes. In alternative embodiment, the paging requests may be sent across color codes.

At action 515(1), the post-dormancy base station router (BSRₚₒₛₜ) receives the paging message 520, which may include the UATI and/or the IP address of the pre-dormancy base station router (BSRₚᵣₑ). The post-dormancy base station router (BSRₚₒₛₜ) then sends a page 525 to the mobile unit (MU). If the mobile unit (MU) responds, the post-dormancy base station router (BSRₚₒₛₜ) knows to direct any reverse-link traffic PPP located at the pre-dormancy base station router (BSRₚᵣₑ). In one embodiment, the post-dormancy base station router (BSRₚₒₛₜ) prepares to instantiate forward and reverse-link RLP.

At action 505(2) and 515(2), the mobile unit (MU) receives a page 530, recognizes its UATI, and initiates the traffic channel setup procedure by sending a Connection Request message (also indicated by the arrow 530) to the post-dormancy base station router (BSRₚₒₛₜ). The post-dormancy base station router (BSRₚₒₛₜ) responds and then the mobile unit MU) and the post-dormancy base station router (BSRₚₒₛₜ) complete the traffic channel setup procedure. Where possible, traffic channel setup can occur simultaneously with other signaling.

At action 515(3), the post-dormancy base station router (BSRₚₒₛₜ) may provide a message 535 to the pre-dormancy base station router (BSRₚᵣₑ) indicating that the post-dormancy base station router (BSRₚₒₛₜ) is reactivating communication to the mobile unit (MU). The message 535 may also inform the pre-dormancy base station router (BSRₚᵣₑ) of the address of the post-dormancy base station router (BSRₚₒₛₜ). At action 510(2), the pre-dormancy base station router (BSRₚᵣₑ) receives the message 535 and reactivates its protocol stack with the exception that forward and reverse-link RLP will be done at the post-dormancy base station router (BSRₚₒₛₜ). This means that on startup, forward-link user data shall be tunneled directly to the post-dormancy base station router (BSRₚₒₛₜ).

At actions 510(3) and 515(4), forward and reverse-link traffic is tunneled between the pre-dormancy base station router (BSRₚᵣₑ) and the post-dormancy base station router (BSRₚₒₛₜ), as indicated by arrow 540. The pre-dormancy base station router (BSRₚᵣₑ) receives the message 540 and reactivates its protocol stack with the exception that forward and reverse-link RLP will be done at the post-dormant BSR. This means that on startup, forward-link user data shall be tunneled directly to the post-dormancy base station router (BSRₚₒₛₜ).

Re-activation of the mobile unit (MU) from dormancy in the above described manner may allow the mobile unit (MU) to receive traffic at the earliest possible time. In the above embodiment, the protocol states are reactivated with RLP being done at the post-dormancy base station router (BSRₚₒₛₜ), which last served the call. Migration of all of the protocol states to the post-dormancy base station router (BSRₚₒₛₜ) can proceed during the active call.

Referring back to FIG. 1, in one alternative embodiment, the mobile unit 110 may determine that a color code associated with the base station router 105(4) has changed while the mobile unit 110 was dormant. For example, the mobile unit 110 may listen on an overhead channel for sector parameters and thereby detect that it is in a new coverage area associated with a new color code. The mobile unit 110 may then transmits its call session identifier to the base station router 105(4), which may determine the address of the base station router 105(2), at least in part based upon the color code of the base station router 105(2) indicated by the call session identifier. The base station router 105(4) may then retrieve call-session state information from the base station router 105(2). In one embodiment, the mobile unit 110 may also request reassignment of the call session identifier when it emerges from dormancy.

In one embodiment, an address translation request message/response to any base station router 105 within a color code group may be provisioned in all the base station routers 105 to avoid having to store all the base station router IP addresses in all the base station routers 105 in all color code regions. Accordingly, one base station router may perform address translation request for all the base station routers 105 in a color coded region when a request is received from a base station router 105 in another color coded group. Alternatively, the message/response may be handled by a network management center (not shown). In that case, the network management center may store all the base station router IP addresses for all color coded regions.

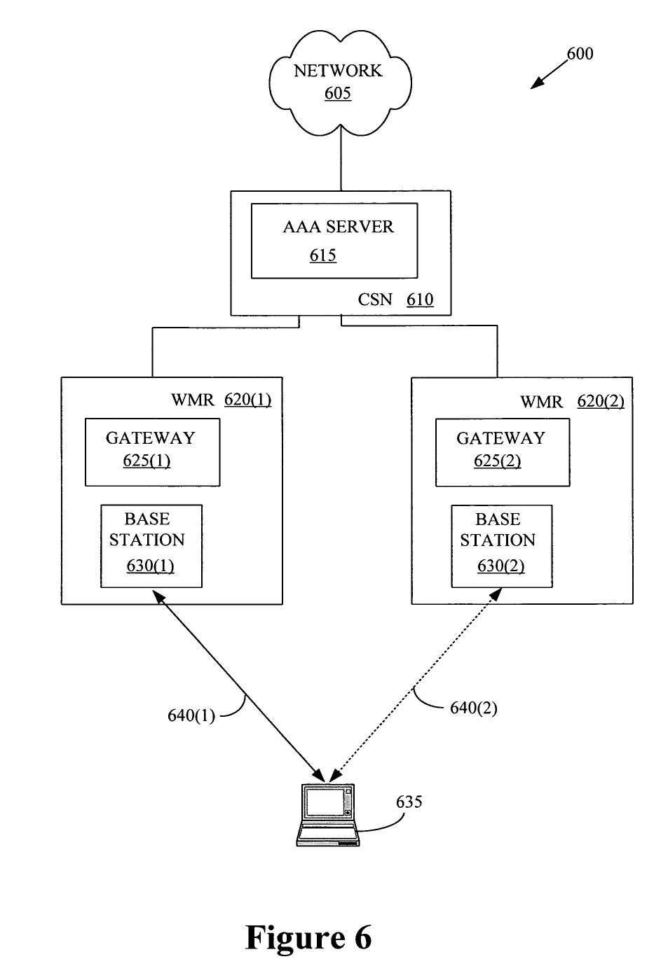

FIG. 6 conceptually illustrates a second exemplary embodiment of a distributed wireless communication system 600. In the illustrated embodiment, the distributed wireless communication system 600 includes a network 605. At least a portion of the network 605 may operate according to an IEEE 802.16 standard and/or a WiMAX standard. However, the present invention is not limited to networks that operate according to these standards. In alternative embodiments, portions of the network 605 may operate according to any wired and/or wireless standard. For example, portions of the network 605 may operate according to standards and/or protocols such as Universal Mobile Telecommunication System (UMTS), Global System for Mobile communications (GSM), Code Division Multiple Access (CDMA, CDMA 2000), IEEE 802.11, Bluetooth, and the like. For another example, the network 605 may include a Public Switched Telephone Network (PSTN), a Plain Old Telephone System (POTS), and the like.

A connectivity serving network (CSN) 610 is communicatively coupled to the network 605. The connectivity serving network 610 provides connectivity to the network 605. Techniques for operating the connectivity serving network 610 are known to persons of ordinary skill in the art and so, in the interest of clarity, only those aspects of the connectivity serving network 610 that are relevant to the present invention will be discussed herein. In the illustrated embodiment, the connectivity serving network 610 includes an authentication, authorization, and accounting (AAA) server 615. The AAA server 615 may provide various authentication services that may be used to authenticate elements of the distributed communication system 600, as well as providing other services.

One or more access serving networks 620(1-2) may be communicatively coupled to the connectivity serving network 610. Hereinafter, in the interest of clarity, the indexes (1-2) will only be used when referring to specific elements and will not be used when a group of elements, such as the access serving networks 620, are referred to collectively. In the illustrated embodiment, the access serving networks are WiMAX routers (WMR) 620. However, persons of ordinary skill in the art having benefit of the present disclosure should appreciate that the present invention is not limited to WiMAX routers 620. In alternative embodiments, any type of access serving network 620 may be used. Furthermore, persons of ordinary skill in the art should appreciate that the present invention is not limited to having two WiMAX routers 620 communicatively coupled to the connectivity serving network 610. In alternative embodiments, any number of WiMAX routers 620 may be communicatively coupled to the connectivity serving network 610.

In the illustrated embodiment, the WiMAX routers 620 include a gateway 625(1-2) and one or more base stations 630(1-2). Although a single gateway 625 and a single base station 630 are shown in each of the WiMAX routers 620, persons of ordinary skill in the art should appreciate that any number of gateways 625 and/or base stations 630 may be implemented in each WiMAX router 620. The WiMAX routers 620 may provide wireless connectivity to one or more mobile units 635. For example, the mobile unit 635 may establish one or more wireless communication links 640(1-2) with one or more of the base stations 630. In the illustrated embodiment, the mobile unit 635 may establish the wireless communication links 640 according to an IEEE 802.16 standard and/or a WiMAX standard. The gateways 625 may then provide connectivity to the network 605 via the connectivity serving network 610.

The WiMAX routers 620 can create, assign, transmit, receive, and/or store call-session state information related to the call sessions established between the WiMAX routers 620 and the mobile unit 635. Portions of the call-session state information may be associated with mobile connectivity and other portions may be associated with network connectivity. In one embodiment, the portion of the call-session state information associated with mobile connectivity includes information used to establish and/or maintain air interfaces between the WiMAX routers 620 and the one or more mobile units 635. For example, the call-session state information associated with mobile connectivity may include media access control (MAC) layer information, which may be used by the base stations 630 to establish and/or maintain the communication links 640. In some embodiments, the call-session state information associated with mobile connectivity may also include information associated with the physical (PHY) layer.

The portion of the call-session state information associated with network connectivity may include information that may be used to establish and/or maintain an interface between the WiMAX router 620 and the network 605 for call sessions associated with one or more of the mobile units 635. In one embodiment, the call-session state information associated with network connectivity includes information associated with layers above the layers associated with mobile connectivity described above. For example, the call-session state information associated with network connectivity may include information associated with the Mobile IP (MIP) layer, which may be used by the gateways 625 to establish and/or maintain connectivity to the network 605.

The mobile unit 635 may become inactive. In the illustrated embodiment, the mobile unit 635 operates according to the IEEE 802.16 standard, which defines two inactive modes: the sleep mode and the idle mode. However, persons of ordinary skill in the art having benefit of the present disclosure should appreciate that the mobile unit 635 is not limited to the sleep and/or idle modes as defined by the IEEE 802.16 standard. The mobile unit 635 may move while it is inactive. For example, the mobile unit 635 may be actively communicating with the base station 630(1) over the wireless communication link 640(1) before becoming inactive. While inactive, the mobile unit 635 may move (or may experience some other change in circumstances) such that the mobile unit 635 is handed off to the base station 630(2). Accordingly, when the mobile unit 635 is reactivated, call-session state information may be transferred from the WiMAX router 620(1) to the WiMAX router 620(2), as will be discussed in detail below.

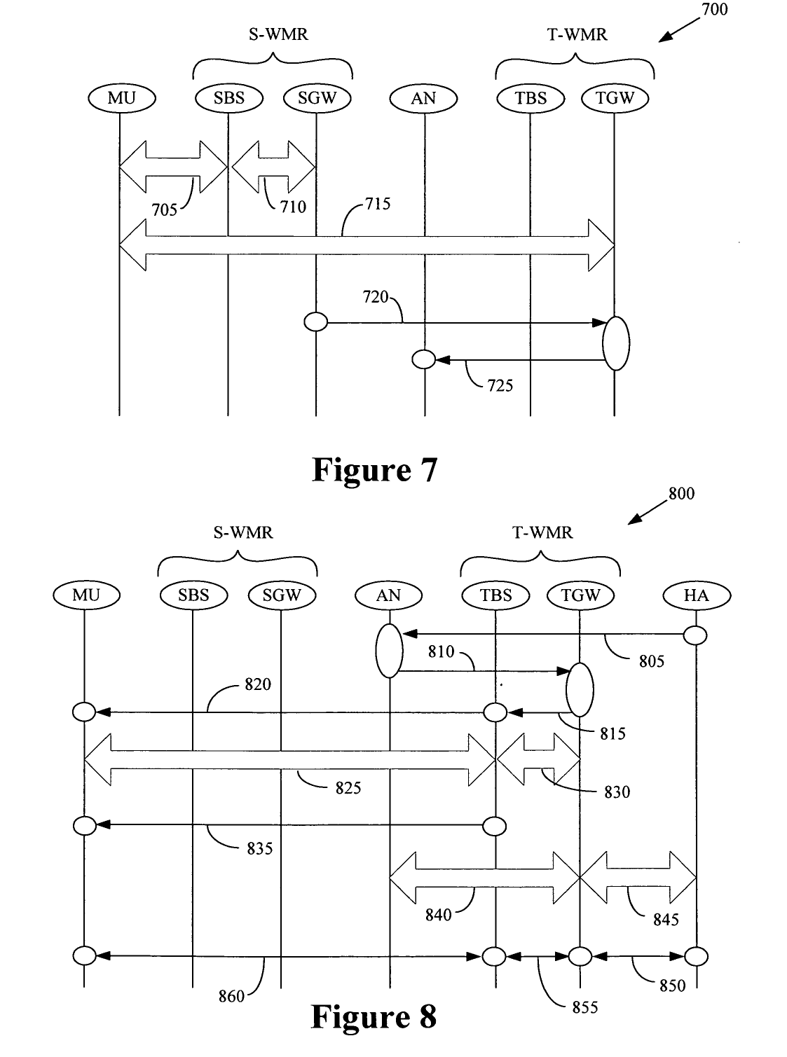

FIG. 7 conceptually illustrates one embodiment of a method 700 of entering a sleep mode and performing a handoff while in the sleep mode. However, persons of ordinary skill in the art should appreciate that similar techniques may be used for entering other inactive modes, such as idle modes, and performing handoffs during these inactive periods. The method 700 will be described in the context of a communication system that includes a mobile unit (MU). The mobile unit (MU) initially has an active communication link with a source base station (SBS) in a source WiMAX router (S-WMR), which also includes a source gateway (SGW) to provide connectivity to a communication network. Persons of ordinary skill in the art should appreciate that, in alternative embodiments, the one or more base stations (SBS) and/or gateways (SGW) in the source WiMAX router (S-WMR) may be implemented in any number of devices deployed at any number of location(s).

Call-session state information associated with the active communication link may be stored in an anchor WiMAX router, or access node (AN). In the illustrated embodiment, the anchor WiMAX router (AN) is different than the source WiMAX router (S-WMR). However, the present invention is not so limited and, in alternative embodiments, the source and anchor routers (S-WMR, AN) may be the same router. The communication system also includes one or more target WiMAX routers (T-WMR), each of which may include a target base station (TBS) and a target gateway (TGW). Persons of ordinary skill in the art should appreciate that, in alternative embodiments, the one or more base stations (TBS) and/or gateways (TGW) in the target WiMAX router (T-WMR) may be implemented in any number of devices deployed at one or more physical location(s). The anchor WiMAX router (AN) may also include any number of base stations (TBS) and/or gateways (TGW) that may be implemented in any number of devices deployed at any number of physical location(s).

To enter the sleep mode, the mobile unit (MU) may notify the source base station (SBS) and/or the source gateway (SGW) and conduct the appropriate sleep mode entry procedures, as indicated by the arrows 705, 710. Sleep mode entry procedures are known to persons of ordinary skill in the art and so, and interest of clarity, only those aspects of these procedures that are relevant to the present invention will be discussed herein. If the mobile unit (MU) moves to an area served by the target base station (TBS), the mobile unit (MU) may handoff from the source base station (SBS) to the target base station (TBS). For example, the mobile unit (MU) may monitor a pilot signal strength associated with the source and/or target base stations (SBS, TBS) and select the base station having the strongest pilot signal strength.

When the mobile unit (MU) has selected the target base station (TBS), a handoff procedure may be performed, as indicated by the arrow 715. Although arrow 715 has endpoints at the mobile unit (MU) and the target gateway (TGW), persons of ordinary skill in the art should appreciate that arrow 715 is intended to represent the signals exchanged between the elements of the communication system as part of the handoff procedure. For example, the mobile unit (MU) may send a Ranging Request message that includes the MAC address of the mobile unit (MU). The MAC state may then be transferred to the target base station (TBS). However, call-session state information associated with the network connectivity, such as the foreign agent state, may remain with the source WiMAX router (S-WMR).

In one embodiment, the mobile unit (MU) does not transmit the location of the call-session state information as part of the Ranging Request message. Moreover, the target gateway (TGW) may not be able to infer the location of the call-session state information from the handover messages exchanged during the selection of the target base station (TBS). Accordingly, the source gateway (SGW) may transmit information indicating the identity of the source WiMAX router (S-WMR) to the target gateway (TGW) to inform the latter of the location of the call-session state information, as indicated by the arrow 720. Once the target base station (TBS) has been selected, an indication or message that contains a target base station identifier (TBS_ID) may be sent over a backhaul network from the target base station (TBS) to the anchor WiMAX router (AN), as indicated by the arrow 725. The anchor WiMAX router (AN) may use the target base station identifier (TBS_ID) to update the location of the mobile unit (MU). The target gateway (TGW) may use the information indicative of the identity of the anchor WiMAX router (AN) to locate the call-session state information (stored by the anchor WiMAX router) when the mobile unit (MU) is activated.

FIG. 8 conceptually illustrates a first exemplary embodiment of a method 800 of re-entry from sleep mode. In the illustrated embodiment, reentry from the sleep mode is initiated by the communication network when data becomes available for the mobile unit (MU). A home agent (HA) receives the data from the communication network and provides a state to the anchor WiMAX router (AN), as indicated by the arrow 805. The data may then be provided (as indicated by the arrow 810) to the target gateway, which may in turn provide the data to the target base station, as indicated by the arrow 815. However, persons of ordinary skill in the art should appreciate that it is not necessary for the data to be provided. In alternative embodiments, some or all of the data may be buffered in the home agent (HA), the anchor WiMAX router (AN), the target gateway (TGW), and/or the target base station (TBS), and an indication that the data is available may be provided to elements downstream of the buffering device.

Upon receiving the data, or an indication that the data is available, the target base station (TBS) provides a traffic indication message to the mobile unit (MU), as indicated by the arrow 820. The mobile unit (MU) periodically wakes up and listens to receive downlink data to determine if there is any traffic on the forward link destined for the mobile unit (MU). If the mobile unit (MU) receives a traffic indication message during one of the listening periods, the mobile unit (MU), the target base station (TBS), and/or the target gateway (TGW) may perform various procedures to reenter the active state, as indicated by arrows 825, 830. For example, the mobile unit (MU) may send a bandwidth request message to the target base station (TBS), exit the sleep mode, and return to normal operation so that the mobile unit (MU) may receive and transmit data. The reception of the bandwidth request message is an indication to the target base station (TBS) that the mobile unit (MU) has returned to normal operations. The target base station (TBS) may then transmit the buffered data, and any other data that is available for transmission, to the mobile unit (MU), as indicated by the arrow 835.

Call-session state information associated with the mobile unit (MU) may be migrated to the target WiMAX router (T-WMR). In the illustrated embodiment, the call-session state information is migrated from the anchor WiMAX router (AN) to the target gateway (TGW) in the target WiMAX router (T-WMR), as indicated by the arrow 840. For example, call-session state information associated with network connectivity, such as foreign agent state information, may be migrated from the anchor WiMAX router (AN) to the target gateway (TGW). As part of the state migration, signaling to the home agent (HA) is performed, as indicated by the arrow 845. Data may then be transmitted from the home agent (HA) to the mobile unit (MU) via the target WiMAX router (T-WMR), as indicated by the arrows 850, 855, and 860.

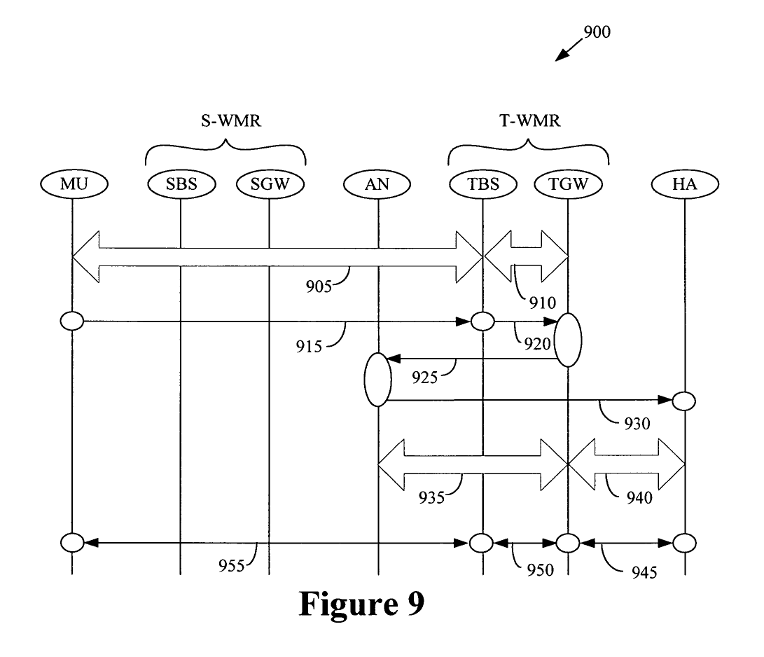

FIG. 9 conceptually illustrates a second exemplary embodiment of a method 900 of re-entry from sleep mode. In the illustrated embodiment, reentry from the sleep mode is initiated by the mobile unit (MU). To reenter from the sleep mode, the mobile unit (MU) provides information indicating that the mobile unit (MU) has woken up from sleep mode to the preferred base station, as indicated by the arrow 905. In this case, the preferred base station is the target base station (TBS). In the second exemplary embodiment of the method 900, the mobile unit (MU) notifies (at 905) the network of the impending re-entry from sleep mode due to the presence of reverse link traffic. For example, the mobile unit (MU) may send an unsolicited bandwidth request message to the target base station (TBS). The target base station (TBS) may then provide information to the target gateway (TGW), as indicated by the arrow 910. For example, the target base station may provide (at 910) an identifier associated with the last serving, or anchor, WiMAX router (AN) along with the MAC address of the mobile unit (MU).

Call-session state information associated with the mobile unit (MU) may be migrated to the target WiMAX router (T-WMR). In one embodiment, the target base station (TBS) may acquire call-session state information associated with mobile connectivity, such as MAC state information transfer, from the last serving, or anchor, WiMAX router (AN). The home agent (HA) may provide forward link data to the mobile unit (MU) after reception of the update of the MAC state information. In the illustrated embodiment, the mobile unit (MU) provides reverse link data to the preferred, or target, base station (TBS), as indicated by the arrow 915. The target base station (TBS) then provides the reverse link data to the target gateway (TGW), which uses information indicative of the location of the anchor gateway (AN) to provide the data to the anchor gateway (AN), as indicated by the arrows 920 and 925. The anchor gateway (AN) may provide the reverse link data to the home agent (HA) which may then provide this data to the network, as indicated by the arrow 930.

Call-session state information associated with network connectivity, such as foreign agent state information, may be migrated from the anchor WiMAX router (AN) to the target gateway (TGW), as indicated by the arrow 935. As part of the state migration, signaling to the home agent (HA) is performed, as indicated by the arrow 940. Data may then be transmitted from the home agent (HA) to the mobile unit (MU) via the target WiMAX router (T-WMR), as indicated by the arrows 945, 950, and 955. In the illustrated embodiment, call-session state information associated with the mobile unit (MU) is migrated to the target WiMAX router (T-WMR), the home agent (HA) provides forward link data to the mobile unit (MU) after reception of the update of the MAC state information, and then the call-session state information associated with network connectivity is migrated from the anchor WiMAX router (AN) to the target gateway (TGW). However, persons of ordinary skill in the art having benefit of the present disclosure should appreciate that the present invention is not limited to this sequence of events. In alternative embodiments, migration of portions of the call-session state information and/or transmission of forward and/or reverse link data may occur in any sequence and/or concurrently.

Although FIGS. 7, 8, and 9 depict techniques that may be utilized to enter sleep mode and for reentry from sleep mode, persons of ordinary skill in the art should appreciate that the present invention is not limited to the sleep mode. In alternative embodiments, similar techniques may be used to enter other inactive states and/or reenter an active state from these inactive states. For example, embodiments of the present invention may be used when a mobile unit enters the idle mode and/or reenters an active mode from the idle mode. In one embodiment, the idle mode may begin after a mobile unit sends a de-registration message to the serving base station, after which the serving base station may release all information pertaining to the mobile unit's connections. The idle mode typically removes any active requirement for handoff and restricts the mobile unit activity to scanning neighboring base stations at discrete time intervals. As in the sleep mode, at any given time, the mobile unit may only listen and can only receive messages from its preferred base station. When the mobile unit moves during idle mode, it should periodically reselect its preferred base station and synchronize to the corresponding broadcast paging interval. However, in contrast to sleep mode, the mobile unit may not inform the new base station that it has been selected as the preferred base station.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of wireless communication in a distributed network comprised of a mobile unit, a plurality of gateways, and a plurality of base stations associated with the gateways, comprising:
receiving information indicative of a first base station from a first gateway associated with the first base station in response to the mobile unit handing off from a second base station to the first base station, the mobile unit being inactive.

2. The method of claim 1, wherein receiving the information indicative of the first base station comprises receiving the information indicative of the first base station in response to information indicative of a location of call-session state information associated with the inactive mobile unit being provided to the first gateway.

3. The method of claim 2, wherein the information indicative of the location of the call-session state information associated with the inactive mobile unit is provided to the first gateway by a second gateway associated with the second base station.

4. The method of claim 2, wherein the information indicative of the location of the call-session state information comprises a location of an anchor WiMAX router.

6. The method of claim 1, comprising updating a location of the mobile unit based on the information indicative of the first base station.

7. The method of claim 1, comprising receiving information indicating that the inactive call session associated with the mobile unit is to be activated.

8. The method of claim 7, wherein receiving information indicating that the inactive call session is to be activated comprises receiving said information from at least one of a home agent and the mobile unit.

9. The method of claim 7, comprising providing at least a portion of the call-session state information in response to receiving the information indicating that the inactive call session associated with the mobile unit is to be activated.

10. A method of wireless communication in a distributed network comprised of a mobile unit, a plurality of gateways, and a plurality of base stations associated with the gateways, comprising:
receiving information indicative of a location of call-session state information associated with the mobile unit in response to the mobile unit handing off from a first base station to a second base station, the mobile unit being inactive.

11. The method of claim 10, wherein receiving the information indicative of the location of the call-session state information comprises receiving the information indicative of the location of the call-session state information from a first gateway associated with the first base station.

12. The method of claim 10, comprising providing information indicative of a second base station associated with the second gateway in response to receiving the information indicative of the location of the call-session state information.

13. The method of claim 12, wherein providing the information indicative of the second base station comprises providing a base station identifier associated with the second base station.

14. The method of claim 12, wherein providing the information indicative of the second base station comprises providing the information indicative of the second base station to an anchor WiMAX router.

15. The method of claim 10, comprising receiving information indicating that the inactive call session associated with the mobile unit is to be activated.

16. The method of claim 15, wherein receiving information indicating that the inactive call session is to be activated comprises receiving said information from at least one of a home agent and the mobile unit.

17. The method of claim 15, comprising accessing at least a portion of the call-session state information in response to receiving the information indicating that the inactive call session associated with the mobile unit is to be activated.

18. A method of wireless communication in a distributed network comprised of a mobile unit, a plurality of gateways, and a plurality of base stations associated with the gateways, comprising:
providing information indicative of a location of call-session state information associated with the mobile unit in response to the mobile unit handing off from a first base station to a second base station, the mobile unit being inactive.

19. The method of claim 18, wherein providing the information indicative of the location of the call-session state information comprises providing the information indicative of the location of the call-session state information to a second gateway associated with the second base station.

20. The method of claim 18, providing the information indicative of the location of the call-session state information comprises providing information indicative of a location of an anchor WiMAX router.
